(19) United States
(12) Patent Application Publication
(10) Pub. No.: US 2010/0209823 A1
(43) Pub. Date: Aug. 19, 2010

(54) POROUS CARBONIZED SUBSTRATE, ITS PREPARATION METHOD AND USES

(75) Inventors: Tse Hao KO, Taichung (TW); Ching Han LIU, Taicheng (TW); Heng Chia LIANG, Taicheng (TW); Jin Wei SHEN, Taichung (TW); Wen Chang HSU, Taichung (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: FENG CHIA UNIVERSITY, Taichung (TW)

(21) Appl. No.: 12/561,463

(22) Filed: Sep. 17, 2009

(30) Foreign Application Priority Data
Feb. 18, 2009 (TW) 098105701

(51) Int. Cl. B32B 5/18; B32B 5/16; B32B 9/00; H01M 2/02; B29C 71/02

(52) U.S. Cl. 429/532; 428/408; 428/323; 428/220; 264/342 R; 429/535

(57) ABSTRACT

A porous carbonized substrate and its preparation method and uses are provided. The porous carbonized substrate has an oxygen content ranging from about 1 wt % to about 13 wt % and a nitrogen content ranging from about 2 wt % to about 16 wt %, based on the total weight of the substrate. The porous carbonized substrate can be prepared by a method comprising the following steps: providing a fiber substrate containing one or more oxidized fibers, one or more polyamide fibers or a mixture thereof; and thermally treating the fiber substrate under an inert gas atmosphere, wherein the thermally treating step comprises putting the fiber substrate in the inert gas atmosphere and increasing the temperature of the inert gas atmosphere to an elevated temperature ranging from about 700° C. to about 2000° C. with a rate of from about 50° C./minute to about 300° C./minute. The porous carbonized substrate is used as a gas diffusion layer of a fuel cell.

This application claims priority to Taiwan Patent Application No. 098105701 filed on Feb. 18, 2009, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a porous carbonized substrate, its preparation method and uses. In particular, the present invention relates to a method for preparing a porous carbonized substrate useful as a gas diffusion layer in a fuel cell and a porous carbonized substrate provided thereby.

2. Descriptions of the Related Art

Due to energy shortages and global greenhouse effects, the development of a fuel cell with a hydrogen supply system has been highly valued. Fuel cells are more environmentally friendly compared to disposable non-chargeable batteries. In addition, fuel cells do not need the time-consuming recharging process as conventional chargeable batteries do. Moreover, the waste of the fuel cells (e.g., water) is not harmful to the environment.

Among various fuel cells, proton exchange membrane fuel cells (PEMFCs) and direct methanol fuel cells (DMFCs) have been widely used in cars, integrated power generation systems and power equipments of various 3C products (e.g., notebook computers, mobile phones) because they can be operated under a low temperature and produce a high current density.

Taking PEMFCs as an example, the primary components of each single cell of the PEMFCs include a membrane-electrode assembly (MEA) and bipolar plates with gas channels. In general, the MEA is consisted of a proton exchange membrane (usually a polymer membrane that acts as an electrolyte), two catalyst layers separately disposed on two sides of the proton exchange membrane and two gas diffusion layers (also known as gas diffusion electrodes) separately disposed on the external sides of the two catalyst layers. The major function of the gas diffusion layer is to uniformly diffuse and distribute gases on the catalyst layer via its porous structure to carry out a cell reaction with the catalyst. Therefore, the gas diffusion layer requires a suitable porosity and a good electric conductivity. Furthermore, to prevent the blockage of the pores of gas diffusion layer by the water produced by the cell reaction and thereby hinder the transportation of reaction gases, the gas diffusion layer also requires a good hydrophobicity to ensure that the reaction gases and water pass smoothly through the gas diffusion layer. To improve the hydrophobicity, a hydrophobic agent (e.g., polytetrafluoroethylene) is usually used for enhancing the hydrophobicity of the gas diffusion layer.

Carbon clothes and carbon papers are two types of the gas diffusion layer used today. Carbon papers are prepared by the following steps: mixing fibers with, for example, polyvinyl alcohol to provide a mixture; preparing fiber papers from the mixture with the use of paper-making techniques; immersing the fiber papers into a resin to provide fiber papers with a certain amount of the resin; and then conducting a thermal carbonization treatment to produce the carbon papers. Carbon clothes are prepared by the following steps: spinning fibers into yarns; weaving the yarns to provide fabrics and then carbonizing the fabrics.

For example, during the carbonization of PAN fibers, the non-carbon elements of the PAN fibers are discharged in a form of small molecular compounds (e.g., H₂O, HCN, NH₃, CO₂, and N₂) to gradually form a carbon basal plane within the fibers. The carbon layer structures in the fibers stack and arrange along the axial direction of the fibers. The crystal widths (La) and crystal heights (Lc) can be measured by an X-ray irradiation apparatus. La and Lc values increase with an elevated carbonization temperature. As described by J. B. Donnet and R. C. Bansal (see Carbon fibers, Marcel Dekker, Inc., 1990, ISBN: 0-8247-7865-0, page 34-36), when the carbonization temperature reaches 1300° C., the composition of the carbon fibers prepared from the PAN fibers are all carbon elements, excepts for about 2 wt % to about 3 wt % nitrogen elements. The research of T. H. Ko also shows a similar result, e.g., the carbon element content of the carbon fibers prepared by carrying out the carbonization at 1300° C. is more than 95 wt % (Influence of continuous stabilization on physical properties and microstructure of PAN-based carbon fibers, Journal of Applied Polymer Science, Vol. 42, 1949-1957, (1991)).

The research of J. B. Donnet and R. C. Bansal described above also indicates that the small molecular compounds must be slowly discharged during the carbonization to improve the strength of the prepared carbon fibers as well as to obtain a better carbon layer structure (i.e., a greater La/Lc value). Therefore, at the beginning of the carbonization, the thermal treatment must be carried out with a low temperature increasing rate (e.g., the temperature increased per minute is less than 10° C.). Accordingly, a high-temperature carbonization process consumes time and also a lot of energy.

The inventors of the invention found that a carbonized substrate with a desired porosity can be quickly prepared without affecting the strength and the usage efficiency of the porous carbonized substrate. The porous carbonized substrate thus prepared has the properties of, for example, high porosity, high hydrophobicity, high oxygen content percentage and high nitrogen content percentage that are suited for use in, for example, a gas diffusion layer of a fuel cell. Furthermore, the porous carbonized substrate prepared by the method of the invention has a smaller area shrinkage, and consequently, a greater yield can be provided with the same amount of raw material.

### SUMMARY OF THE INVENTION

An objective of the present invention is to provide a porous carbonized substrate, having an oxygen content ranging from about 1 wt % to about 13 wt % and a nitrogen content ranging from about 2 wt % to about 16 wt %, based on the total weight of the substrate. The porous carbonized substrate can is useful as a gas diffusion layer of a fuel cell.

Another objective of the present invention is to provide a method for preparing the aforesaid porous carbonized substrate, comprising the following steps: providing a fiber substrate containing one or more oxidized fibers, one or more polyamide fibers or a mixture thereof; and thermally treating the fiber substrate under an inert gas atmosphere, wherein the thermally treating step comprising putting the fiber substrate in the inert gas atmosphere and increasing the temperature of the inert gas atmosphere to an elevated temperature ranging from about 700° C. to about 2000° C. with a rate of from about 50° C./minute to about 300° C./minute.

The aforesaid objectives, the features and the advantages of the present invention are further described in the following paragraphs with some embodiments.

### BRIEF DESCRIPTION OF THE DRAWINGS

No figures.

### DESCRIPTION OF THE PREFERRED EMBODIMENT

The following will describe some embodiments of the present invention. However, the present invention may be embodied in other embodiments without departing from the characteristics of the invention and should not be limited to the embodiments described in the specification.

The porous substrate of the present invention has an oxygen content ranging from about 1 wt % to about 13 wt % and a nitrogen content ranging from about 2 wt % to about 16 wt %, based on the total weight of the substrate. The carbon layer structure of a conventional carbonized substrate contains almost no oxygen elements and merely contains few nitrogen elements. The rest of the structure is made of carbon elements. In general, if the content of nitrogen or oxygen element in the carbon layer structure is too low (e.g., a nitrogen content of less than 2 wt % or an oxygen content of less than 1 wt %), a complete carbon basal plane will be formed and this renders the substrate to be non-porous. On the contrary, if the content of nitrogen or oxygen element in the carbon layer structure is too much, a disordered carbon basal plane will be formed and this may affect the electric conductivity of the substrate.

The porous carbonized substrate of the present invention can is useful as a gas diffusion layer of a fuel cell, and typically has a thickness ranging from about 0.1 mm to about 1.0 mm, preferably from about 0.2 mm to about 0.5 mm. Besides, the carbon layer structure of the porous carbonized substrate according to the present invention preferably has a crystal height (Lc) ranging from about 2.0 nm to about 4.0 nm.

As described hereinbefore, the carbonized substrate, as a gas diffusion layer of a fuel cell, must have a suitable porosity and a good electric conductivity. It has been discovered that if the porosity of the carbonized substrate is less than about 15% or the weight per unit area of the carbonized substrate is more than about 800 g/m², the substrate structure is too dense and therefore disadvantageous for gas diffusion. On the contrary, if the porosity of the carbonized substrate is more than about 60% or the weight per unit area is less than about 20 g/m², the substrate structure will have an excessively loose material strength and a poor durability, causing difficulty in the subsequent processing. When the porous carbonized substrate of the present invention is used as a gas diffusion layer of a fuel cell for providing a good gas permeability that exchanges gases to carry out the cell reaction, the porosity of the substrate preferably ranges from about 15% to about 60%, more preferably from about 18% to about 40%, and the weight per unit area of the substrate preferably ranges from about 20 g/m² to about 800 g/m², more preferably from about 40 g/m² to about 500 g/m².

As shown in the following examples, the porous carbonized substrate of the present invention has an excellent hydrophobicity that prevents the pores of the gas diffusion layer from being occupied by the water produced by the cell reaction that would otherwise hinder the transportation of the reaction gases. That is, the porous carbonized substrate of the present invention can be directly used as the diffusion layer of a fuel cell (particularly the PEMFC and DMFC) without carrying out a hydrophobicity-enhancement treatment in advance.

The present invention also relates to a method for preparing the aforesaid porous carbonized substrate. The method can quickly prepare the porous carbonized substrate and comprises the following steps: providing a fiber substrate containing one or more oxidized fibers, one or more polyamide fibers or a mixture thereof; and thermally treating the fiber substrate under an inert gas atmosphere, wherein the thermally treating step comprises putting the fiber substrate in the inert gas atmosphere and increasing the temperature of the inert gas atmosphere to an elevated temperature ranging from about 700° C. to about 2000° C. with a rate of from about 50° C./minute to about 300° C./minute. In a preferred embodiment of the method, the porous carbonized substrate thus prepared has an area shrinkage of less than 3%.

According to the method of the present invention, to prevent ashing the fibers during the thermal treatment, the thermally treating step should be carried out under the protection of an inert gas atmosphere. For example, an inert gas selected from the following group can be used for carrying out the carbonization treatment: nitrogen gas, helium gas, argon gas or combinations thereof Optionally, the thermally treating step may be carried out under a tensionless condition (i.e., under the condition that the fiber substrate is not pulled or fixed by any external force).

The thermally treating step comprises a temperature increasing stage and an optional temperature holding stage wherein the temperature is substantially conatant. The temperature increasing stage heats the inert gas atmosphere to a predetermined elevated temperature with a rate of from about 50° C./minute to about 300° C./minute, preferably from about 150° C./minute to about 300° C./minute. An optional substantial temperature holding stage is then carried out, i.e., the elevated temperature remains substantially constant for a while to complete the carbonization of the fiber substrate. The elevated temperature generally ranges from about 700° C. to about 2000° C., preferably from about 800° C. to about 1700° C. The duration of the temperature holding stage, if adopted, ranges from about 1 second to about 15 minutes. For example, in some embodiments of the present invention, a temperature increasing stage with a temperature increasing rate of from about 150° C./minute to about 300° C./minute and a temperature holding stage with a duration of about 10 minutes are adopted.

The fiber substrate suitable for the present invention may be a woven fabric or a non-woven fabric (e.g., a non-woven cloth and a mat). For example, a woven fabric suitable for the invention may be prepared by the following steps:
(1) mixing oxidized fibers and polyamide fibers to provide a fiber mixture when both the oxidized fibers and the polyamide fibers are used; if only the oxidized fibers or the polyamide fibers are used, directly carrying out step (2);
(2) spinning the fibers or the fiber mixture to provide a (mixed) yarn, wherein the yarn number of the yarn preferably ranges from about NE 4 to about NE 50, more preferably from about NE 5 to about NE 40, because an exceeding number of yarn will increase difficulty in the weaving process; and
(3) weaving the (mixed) yarn to provide a desired (mixed) woven fabric.

The oxidized fibers and/or the polyamide fibers may be cut into short fibers prior to the spinning step in the above operation. The spinning step may be a single process or may be carried out with a slubbing process and a fine-spinning process. For example, the spinning step may be carried out by drafting the fiber mixture 3 to 10 times in length to provide a roving and then drafting the roving 10 to 15 times in length to provide a yarn. Afterwards, a doubling process may be carried out optionally to provide a doubled yarn.

The weaving process can be carried out by any suitable weaving technique, such as a looming method, a knitting method, or a combination thereof, to provide the mixed woven fabric. The looming method can provide a plain or twill weave fabric, and the knitting method can provide a knit weave fabric. When the porous carbonized substrate of the present invention is used as a gas diffusion layer, it is preferably prepared by a looming method since the gas diffusion layer must let the fuel gas uniformly diffuse and would also require a smooth surface that comes into contact with the catalyst layer.

Any suitable polyamide fibers are useful in the method of the present invention. For example, the polyamide fibers may be aromatic polyamide fibers, such as Normex or Kevlar produced by Dupont Company, Technora produced by Teijin Company, or Twaron produced by Teijin Twaron Company.

Any suitable oxidized fibers are useful in the method of the present invention. In general, the oxidized fiber can be prepared by thermally treating fibers selected from a group consisting of polyacrylonitrile (PAN) fibers, asphalt fibers, phenolic fibers, cellulose fibers, and combinations thereof. In some embodiments of the present invention, the polyacrylonitrile fibers are thermally treated to provide the oxidized fibers. For example, the oxidized fibers are prepared by thermally treating the PAN fibers in the air at 200° C. to 300° C. Commercially available fireproof fibers, such as Panox produced by SGL Carbon Group Company, Pyromex produced by Toho Tenax Company, Pyron produced by Zoltek Company, and Lastan produced by Asahi Kasei Company, are also the oxidized fibers suitable for the method of the present invention.

The porous carbonized substrate prepared by the method of the present invention is particularly suitable to be used as a gas diffusion layer of a fuel cell, such as PEMFC and DMFC, i.e., the anode and the cathode of the fuel cell. The material and the structure of each component of the fuel cell are well-known by people with ordinary skill in the art, such as those described in Taiwan Patent No. I272739 and U.S. Patent Publication No. 2007/0117005 A1, incorporated hereinto for reference.

The embodiments below are illustrated to further describe the present invention, wherein the adopted measuring apparatuses and methods are as follows:

### (A) Gas Permeability Measuring Method

The gas permeability measuring apparatus: Gurley Model 4320

The measuring specification: ASTM D726-58

The capacity of the barrel for measuring the gas permeability: 300 cc

The weight of the barrel for measuring the gas permeability: 5 oz

The measuring area: 1 square inch

A barrel for measuring the gas permeability was located at the predetermined position before the test. A sample with an area more than 1 square inch was put on the holder of the gas permeability measuring apparatus. The program was operated according to the ASTM D726-58 testing standard procedure, and once the procedure was confirmed without any inaccuracies, the barrel for measuring the gas permeability was lightly put down. After the barrel for measuring the gas permeability had gone through the whole procedure, a value was obtained. The lower the obtained value, the higher the gas permeability. In other words, the higher the obtained value, the lower the gas permeability.

### (B) Cell Performance Measuring Method

The cell performance testing apparatus: FCEDPD50 from Asia Fuel Cell Technologies, Ltd

The model of the electronic load apparatus: Chroma 63103

The testing conditions:
The anode fuel: hydrogen gas (purity: 99.999%) with a flow velocity of 500 cc/minute
The cathode fuel: Industrial oxygen gas with a flow velocity of 500 cc/minute
The humidification temperature of the anode and the cathode: 40° C.
The relative humidity at the exit of the humidification bottle: 95%
The test temperature of the cell: 40° C.
The fabricating torsion of the cell: 40 kgf-cm
The reacting area of the cell: 25 cm²

The prepared sample was cut into a size of 5 cm×5 cm, and then, without carrying out a hydrophobic treatment or a leveling treatment, the sample was fabricated with a catalyst coated membrane (CCM; Model: Dupont™, type NRE-211) produced by Dupont Company, USA, into a membrane-electrode assembly (MEA) with a torsion of 40 kgf-cm. A graphite plate with serpentine-type grooved trenches is used as bipolar plates. A stainless steel plate and a Teflon Gasket were used for the final package to provide a fuel cell. The cell performance was tested under the following conditions: the gas flow velocity at the anode (hydrogen gas) was 500 cc/minute; the gas flow velocity at the cathode (oxygen gas) was 500 cc/minute; the pressure was 1 kg/cm²; and the temperature is 40° C.

### (C) Method for Measuring the Stack Thickness of the Carbon Layer Structure (i.e., the Crystal Height (Lc))

Apparatus: X-ray diffraction apparatus (Model: MXP-3 X-ray Diffraction)

Testing method: The sample was measured by the X-ray diffraction apparatus, wherein the scanning angle was 10° to 60°, the Scherrer constant (K) was 0.9, and the diffraction wavelength (λ) of the diffraction line was 0.1543 nm.

### (D) Elemental Analyst Measuring Method

Apparatus: Elemental Analyzer from Elementar Company, Germany (Model: Universal CHNOS Elemental Analyzer Vario EL III)

The sample is burned with pure oxygen at 1150° C. to form carbon dioxide and nitrogen oxide. The carbon dioxide and the nitrogen oxide are then reduced to carbon dioxide and nitrogen gas by pure copper. The carbon dioxide and the nitrogen gas were introduced into the analyzer to analyze the weight percentage of carbon and nitrogen.

### (E) Porosity Measuring Method

Apparatus: balance (measuring precision: 0.0001 g) and oven

Testing standard: ASTM D-570 testing method

The sample is placed into the oven (120° C. (±5° C.)) for 24 hours. The dried sample was taken out from the oven and then weighted to obtain a value W₁. After immersing the dried sample in reverse osmosis water for 24 hours, the sample was taken out from the water and then the surface of the sample was wiped. The sample was then weighted to obtain a value W₂. The porosity of the sample was calculated by the following formula:

[(W₂−W₁)W₁]×100%=porosity (%).

### (F) Area Shrinkage Measuring Method

Apparatus: vernier scale

Before the thermally treating step, the width and the length of the un-carbonized fiber were measured by the vernier scale to obtain the area of the fiber (A₁). After the thermally treating step, the width and the length of the carbonized fiber were again measured by the vernier scale to obtain the area of the carbonized fiber (A₂). The area shrinkage of the sample was calculated by the following formula:

[(A₂−A₁)/A₁]×100%=area shrinkage (%).

### (G) Contact Angle Measuring Method

Apparatus: GBX model D-S Instruments, France

The hydrophobic property of the substrate to be measured was generally estimated according to the contact angle at the contacting point of the surface of the substrate to be measured and the dropped liquid drop. The contact angle was the angle between the tangent line of the drop at the contacting point and the solid-liquid interface. The contact angle was calculated by Young's equation.

### Example 1

The short oxidized fibers produced by Zoltek Company, USA, were adopted. The oxidized fibers were cut into a length of 63 nm, and then drafted by a roving frame to provide a roving. The roving was subsequently drafted by a spinning frame to provide a yarn. The resulting yarn was knitted into a woven fabric with a thickness of 0.8 mm and a weight of 460 g/m².

Under the protection of nitrogen gas, the prepared woven fabric was heated to 1300° C. with a rate of 190° C./minute. The temperature was held for about 10 minutes, and then cooled down to room temperature with the same rate of 190° C./minute. A porous carbonized substrate with a thickness of 0.58 mm and a weight of 251 g/m² was obtained. The porous carbonized substrate was tested by the aforesaid methods and the testing results were recorded in Table 1. As shown in Table 1, the porosity of the porous carbonized substrate was 24.7%, the area shrinkage of the porous carbonized substrate was 0.2%, the nitrogen content of the porous carbonized substrate was 13.42 wt %, and the oxygen content of the porous carbonized substrate was 11.79 wt %.

The porous carbonized substrate was used to fabricate a fuel cell. The performance of the fuel cell was then tested according to the aforesaid method and the testing results were also recorded in Table 1. As shown in Table 1, at a voltage of 0.5 V, the measured current density was 1017 mA/cm², and the measured maximum power density was 566 mW/cm².

### Example 2

A porous carbonized substrate was produced by using the same woven fabric and the same methods of Example 1, while the heating rate and the cooling rate were both raised to 220° C./minute. The porous carbonized substrate with a thickness of 0.60 mm and a weight of 243 g/cm² was obtained. The porous carbonized substrate was tested by the aforesaid methods and the testing results were recorded in Table 1. As shown in Table 1, the porosity of the porous carbonized substrate was 23.0%, the area shrinkage of the porous carbonized substrate was 0.5%, the nitrogen content of the porous carbonized substrate was 13.65 wt %, and the oxygen content of the porous carbonized substrate was 12.95 wt %.

The porous carbonized substrate was used to fabricate a fuel cell. The performance of the fuel cell was then tested according to the aforesaid method and the testing results were recorded in Table 1. As shown in Table 1, at a voltage of 0.5 V, the measured current density was 978 mA/cm², and the measured maximum power current was 541 mW/cm².

### Example 3

A porous carbonized substrate was produced by using the same woven fabric and the same methods of Example 1, while the heating rate and the cooling rate were both raised to 250° C./minute. The porous carbonized substrate with a thickness of 0.57 mm and a weight of 237 g/cm² was obtained. The porous carbonized substrate was tested by the aforesaid methods and the testing results were recorded in Table 1. As shown in Table 1, the porosity of the porous carbonized substrate was 37.0%, the area shrinkage of the porous carbonized substrate was 2.5%, the nitrogen content of the porous carbonized substrate was 13.81 wt %, and the oxygen content of the porous carbonized substrate was 10.19 wt %.

The porous carbonized substrate was used to fabricate a fuel cell. The performance of the fuel cell was then tested according to the aforesaid method and the testing results were recorded in Table 1. As shown in Table 1, at a voltage of 0.5 V, the measured current density was 1132 mA/cm², and the measured maximum power current was 625 mW/cm².

### Example 4

A porous carbonized substrate was produced by using the same woven fabric and the same methods of Example 1, while the heating rate and the cooling rate were both raised to 280° C./minute. The porous carbonized substrate with a thickness of 0.61 mm and a weight of 232 g/cm^{2,} was obtained. The porous carbonized substrate was tested by the aforesaid methods and the testing results were recorded in Table 1. As shown in Table 1, the porosity of the porous carbonized substrate was 32.0%, the area shrinkage of the porous carbonized substrate was 2.8%, the nitrogen content of the porous carbonized substrate was 15.98 wt %, and the oxygen content of the porous carbonized substrate was 7.49 wt %.

The porous carbonized substrate was used to fabricate a fuel cell. The performance of the fuel cell was then tested according to the aforesaid method and the testing results were recorded in Table 1. As shown in Table 1, at a voltage of 0.5 V, the measured current density was 1128 mA/cm², and the measured maximum power current was 633 mW/cm².

### Comparative Example 1

A porous carbonized substrate was produced by using the same woven fabric of Example 1, wherein the woven fabric is treated with a method of the prior art increasing the temperature with a slow rate. The woven fabric was heated to 1300° C. with a rate of 2° C./minute. The temperature was held for 10 minutes, and then cooled to room temperature with the same rate of 2° C./minute. The porous carbonized substrate with a thickness of 0.57 mm and a weight of 240 g/cm² was obtained. The porous carbonized substrate was tested by the aforesaid methods and the testing results were recorded in Table 1. As shown in Table 1, the porosity of the porous carbonized substrate was 12.6%, the area shrinkage of the porous carbonized substrate was 8.7%, the nitrogen content of the porous carbonized substrate was 1.35 wt %, and the oxygen content of the porous carbonized substrate was 0 wt %.

The porous carbonized substrate was used to fabricate a fuel cell. The performance of the fuel cell was then tested according to the aforesaid method and the testing results were also recorded in Table 1. As shown in Table 1, at a voltage of 0.5 V, the measured current density was 1172 mA/cm², and the measured maximum power density was 628 mW/cm².

### Comparative Example 2

A porous carbonized substrate was produced by using the same woven fabric and the same methods of Example 1, while the heating rate and the cooling rate were both raised to 310° C./minute. The porous carbonized substrate with a thickness of 0.59 mm and a weight of 218 g/cm² was obtained. The porous carbonized substrate was tested by the aforesaid methods and the testing results were recorded in Table 1. As shown in Table 1, the porosity of the porous carbonized substrate was 16.1%, the area shrinkage of the porous carbonized substrate was 3.2%, the nitrogen content of the porous carbonized substrate was 16.44 wt %, and the oxygen content of the porous carbonized substrate was 12.24 wt %.

The porous carbonized substrate was used to fabricate a fuel cell. The performance of the fuel cell was then tested according to the aforesaid method and the testing results were also recorded in Table 1. As shown in Table 1, at a voltage of 0.5 V, the measured current density was 401 mA/cm², and the measured maximum power current was 208 mW/cm².

TABLE 1

| | | | | | Carbon | | | Maximum |
|---|---|---|---|---|---|---|---|---|
| | Nitrogen | Oxygen | | Area | layer | Contact | *Current | power |
| | content | content | Porosity | shrinkage | structure | angle | density | density |
| | (wt %) | (wt %) | (%) | (%) | (Lc, nm) | (°) | (mA/cm²) | (mW/cm²) |
| Example 1 | 13.42 | 11.79 | 24.7 | 0.2 | 2.55 | 125 | 1017 | 566 |
| Example 2 | 13.65 | 12.95 | 23.0 | 0.5 | 2.56 | 108 | 978 | 541 |
| Example 3 | 13.81 | 10.19 | 37.0 | 2.5 | 2.53 | 100 | 1132 | 625 |
| Example 4 | 15.98 | 7.49 | 32.0 | 2.8 | 2.54 | <90 | 1128 | 633 |
| Comparative | 1.35 | 0 | 12.6 | 8.7 | 2.57 | 135 | 1172 | 628 |
| example 1 | | | | | | | | |
| Comparative | 16.44 | 12.24 | 16.1 | 3.2 | 1.94 | <90 | 401 | 208 |
| example 2 | | | | | | | | |

*The current density was measured at a voltage of 0.5 V.

As seen in Table 1, the porous carbonized substrates of Examples 1 to 4 of the present invention have an abundant nitrogen content and oxygen content. Compared to the porous carbonized substrate of Comparative example 1, the porous carbonized substrate of the invention has a better porosity. Furthermore, according to the contact angle, it can be seen that the porous carbonized substrate of the present invention also has a good hydrophobicity. The aforesaid properties are all advantageous for the porous carbonized substrate of the present invention to provide a better gas permeability and a better hydrophobicity when used as a gas diffusion layer of a fuel cell. By comparing the current density and the maximum power density, it is evident that the method of the present invention can quickly prepare a porous carbonized substrate with a desired porosity, and the fuel cell with the porous carbonized substrate of the present invention has comparable cell properties as that of the known fuel cell.

Additionally, the carbon layer structures (see Lc value) of the porous carbonized substrates of Examples 1 to 4 are not obviously different from that of the carbonized substrate of Comparative example 1. It is obvious that the method of the present invention does not damage the carbon layer structure caused by processing the carbonization treatment with a high temperature increasing rate as described in the prior art.

Furthermore, it is evident that the area shrinkage of the carbonized substrate according to the present invention (Examples 1 to 4) is obviously smaller than that of the carbonized substrate prepared by the method of the prior art (Comparative example 1). In other words, when using the same amount of the material, the method of the present invention can quickly prepare a desired porous carbonized substrate, and the yield is much better than that of the prior art method.

Comparative example 2 also prepared the carbonized substrate by the rapid temperature increasing method. However, the temperature increasing rate was so high that the carbon structure of the prepared carbonized substrate was damaged (see Lc value), as shown in the reference. As a result, the performance of a cell with such prepared carbonized substrate as a gas diffusion layer is poor.

Given the above, a desired porous carbonized substrate can be quickly prepared by the method of the present invention, and the porous carbonized substrate thus prepared does not have the problem of poor carbon layer structure as that cited in the reference. Furthermore, the prepared porous carbonized substrate also has a good porosity and a good hydrophobicity. When the porous carbonized substrate is used as a gas diffusion layer of a fuel cell, the substrate can provide at least the same cell properties as that of the known carbonized substrate.

The above disclosure is related to the detailed technical contents and inventive features thereof. People skilled in this field may proceed with a variety of modifications and replacements based on the disclosures and suggestions of the present invention as described without departing from the characteristics thereof. Nevertheless, although such modifications and replacements are not fully disclosed in the above descriptions, they have substantially been covered in the following claims as appended.

What is claimed is:

1. A porous carbonized substrate, having an oxygen content ranging from about 1 wt % to about 13 wt % and a nitrogen content ranging from about 2 wt % to about 16 wt %, based on the total weight of the substrate.

2. The porous carbonized substrate of claim 1, having a porosity ranging from about 15% to about 60%.

3. The porous carbonized substrate of claim 2, having a porosity ranging from about 18% to about 40%.

4. The porous carbonized substrate of claim 1, comprising a carbon layer structure, wherein the carbon layer contains a carbon crystal having a crystal height (Lc) ranging from about 2.0 nm to about 4.0 nm.

5. The porous carbonized substrate of claim 1, having a thickness ranging from about 0.1 mm to about 1.0 mm.

6. The porous carbonized substrate of claim 1, having a thickness ranging from about 0.2 mm to about 0.5 mm.

7. The porous carbonized substrate of claim 1 for use as a gas diffusion layer of a fuel cell.

8. A method for preparing the porous carbonized substrate of claim 1, comprising:
providing a fiber substrate containing one or more oxidized fibers, one or more polyamide fibers or a mixture thereof; and
thermally treating the fiber substrate under an inert gas atmosphere, wherein the thermally treating step comprises putting the fiber substrate in the inert gas atmosphere and increasing the temperature of the inert gas atmosphere to an elevated temperature ranging from about 700° C. to about 2000° C. with a rate of from about 50° C./minute to about 300° C./minute.

9. The method of claim 8, wherein the thermally treating step further comprises maintaining the fiber substrate in the inert gas atmosphere under the elevated temperature for about 1 second to about 15 minutes.

10. The method of claim 9, wherein the fiber substrate is maintained in the inert gas atmosphere for about 10 minutes.

11. The method of claim 8, wherein the fiber substrate is a woven fabric or a non-woven fabric.

12. The method of claim 8, wherein the oxidized fiber is selected from a group consisting of polyacrylonitrile fiber, asphalt fiber, phenolic fiber, cellulose fiber, and combinations thereof.

13. The method of claim 12, wherein the oxidized fiber is polyacrylonitrile fiber.

14. The method of claim 8, wherein the inert gas is selected from a group consisting of nitrogen gas, helium gas, argon gas, and combinations thereof.

15. The method of claim 8, wherein the rate of increasing the temperature of the inert gas atmosphere ranges from about 150° C./minute to about 300° C./minute.

16. The method of claim 8, wherein the elevated temperature ranges from about 800° C. to about 1700° C.

17. The method of claim 8, wherein the fiber substrate provided after the thermally treating step has an area shrinkage of less than about 3%.
